(19) United States
(12) Patent Application Publication
(10) Pub. No.: US 2018/0035048 A1
(43) Pub. Date: Feb. 1, 2018

(54) Apparatus and Method for Facilitating Capture of Panoramic Images on a Mobile Computing Device

(71) Applicant: EveryScape, Inc., Newton, MA (US)

(72) Inventors: James Schoonmaker, Arlington, MA (US); Matthew Dunn, Marlborough, MA (US); Stephen Seibert, Woburn, MA (US)

(21) Appl. No.: 15/224,068

(22) Filed: Jul. 29, 2016

(51) Int. Cl. H04N 5/232; H04N 5/225

(52) U.S. Cl. CPC H04N 5/23238; H04N 5/2253

(57) ABSTRACT

A portable device facilitates capture of panoramic images on a mobile computing device. The device includes a receptacle configured to house a mobile computing device. The device also includes a platform with a member, with an axis of rotation, that is configured to interface with the receptacle to offset radially the mobile computing device from the axis of rotation by a predefined distance, such that an entrance pupil of a lens system of the mobile computing device is aligned with the axis. The platform also includes a motor that drives the member at different velocities so that the mobile computing device captures an image for a panoramic image when a velocity of the member is substantially zero for a threshold period of time.

### TECHNICAL FIELD

The present invention relates to an apparatus and method for facilitating capture of panoramic images on a mobile computing device. More particularly, exemplary apparatuses and methods leverage the mobile computing device's feature of waiting for the device to become still before capturing images, by alternating between moving the mobile computing device to different positions for image capture and halting the motion for predetermined periods of time.

### BACKGROUND ART

Conventional cameras for creating panoramic images are expensive, and they can require meticulous preparation to obtain quality images. For example, some of these cameras include two lenses, each coupled to its own sensor, that face opposite directions. The cameras capture separate images using each lens-sensor pair and aggregate the images to create a panoramic image. An alternate conventional camera may include a single lens and sensor, and the camera executes software to drive a motor for rotating the lens and sensor to capture two or more images for a panoramic image. When a user deploys this type of camera, the quality of the camera set-up greatly impacts the quality of the images captured, and consequently, the resulting panoramic image.

These conventional cameras pose a number of drawbacks for users. Because they are specialized for panoramic images, they have limited versatility but still require users to incur significant costs in purchasing them. Furthermore, since the quality of the final panoramic images depends on the camera set-up, users must be skilled at preparing the cameras for image capture. Thus, conventional cameras pose a number of obstacles to obtaining panoramic image.

### SUMMARY OF THE EMBODIMENTS

In accordance with one embodiment of the invention, a portable device facilitates capture of panoramic images on a mobile computing device. The device includes a receptacle configured to house a mobile computing device. The device also includes a platform with a member, with an axis of rotation, that is configured to interface with the receptacle to offset radially the mobile computing device from the axis of rotation by a predefined distance, such that an entrance pupil of a lens system of the mobile computing device is aligned with the axis. The platform also includes a motor that drives the member at different velocities so that the mobile computing device captures an image for a panoramic image when a velocity of the member is substantially zero for a threshold period of time.

The velocities may be angular velocities. The member may be a circular member. The motor may be a mechanical motor. The motor may be coupled to a processor that executes code to drive the member. The motor may drive the member to alternate between rotating and remaining still. Furthermore, the motor may drive the member to rotate by a predetermined number of degrees. The predetermined number of degrees may be thirty-six (36). The predefined distance of radial offset between the mobile computing device and the axis of rotation of the member may be less than 0.5 inches.

In accordance with another embodiment of the invention, a method facilitates capture of panoramic images on a mobile computing device. The method initiates, by a mobile computing device, a program to capture images of a scene for a panoramic image when the mobile computing device is stationary. The method also captures, by a mobile computing device, a first image of a scene at a first location. The method further drives, by a motor, a member configured to interface with a receptacle containing the mobile computing device from the first location to a second location. The method additionally halts, by the motor, further motion of the member for a predetermined period of time. The method determines, by a sensor of the mobile computing device, a lack of motion of the mobile computing device for a threshold period of time. In response to the lack of motion, the method captures, by the mobile computing device, a second image of the scene at the second location. Lastly, the method creates the panoramic image from the first and second images of the scene.

The method may drive, by the motor, the member from the first location to the second location at a non-zero angular velocity. Alternatively, the method may drive, by the motor, the member to rotate by a predetermined number of degrees.

In accordance with another embodiment of the invention, a computer-readable medium has computer program code non-transitorily stored thereon, and the computer program code facilitates capture of panoramic images on a mobile computing device. The program code includes code for monitoring motion of the mobile computing device, including substantially zero and substantially non-zero velocities of the mobile computing device. The program code also includes code for capturing at least one image of a scene in response to determinations that the mobile computing device has remained at a substantially zero velocity for a threshold period of time.

### BRIEF DESCRIPTION OF THE DRAWINGS

The foregoing features of embodiments will be more readily understood by reference to the following detailed description, taken with reference to the accompanying drawings, in which:

FIG. 1 depicts a platform for an exemplary apparatus that leverages features of panoramic image capturing programs on mobile computing devices to facilitate the capture of panoramic images;

FIG. 2 depicts an isometric view of a receptacle for the mobile computing device when mounted on a rotating member of a platform;

FIG. 3 depicts exemplary elements of the platform of FIG. 1;

FIGS. 4-6 depict side, front, and top views of the receptacle and rotating member, illustrating the configuration of the receptacle to offset the mobile computing device from the axis of rotation of the member; and

FIGS. 7-10 depict top, side, bottom, and isometric views of an exemplary set of gears that may be used in the platform of the apparatus of FIG. 1.

### DETAILED DESCRIPTION OF SPECIFIC EMBODIMENTS

### Apparatus and Methods for Enabling Capture of Panoramic Images on Mobile Computing Devices

The inventors have developed an apparatus and methods that enable anyone with a mobile computing device (e.g., a smartphone) to obtain high quality panoramic images. The apparatus is configured to house a mobile computing device, and the apparatus further leverages features of existing panoramic image capturing software (also referred to herein as “panoramic software”) on the device to ensure that the device captures excellent panoramic images. In particular, the apparatus uses the panoramic software's reliance on the device's accelerometer(s) to determine whether the device is in motion. By moving the mobile computing device to different positions for image capture, and then halting motion for predetermined periods of time, the apparatus may ensure that the mobile computing device captures the images needed to create a panoramic image, but only when the apparatus has halted motion at the designated positions.

Leveraging existing features of panoramic software obviates the need for the apparatus to communicate with the mobile computing device. Since the user does not need to initiate or ensure such communication, use of the apparatus requires less skill, especially compared to a conventional camera for capturing panoramic images. Furthermore, because the apparatus is simple, portable, and lightweight, a user may acquire the apparatus at low cost and couple it to the user's own mobile computing device for obtaining panoramic images with ease.

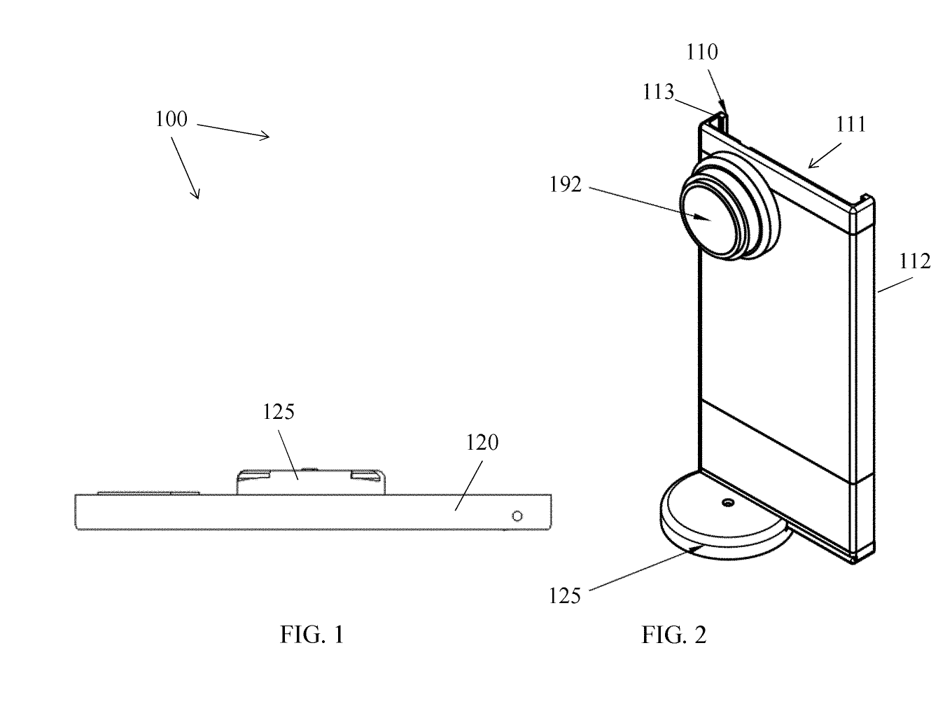

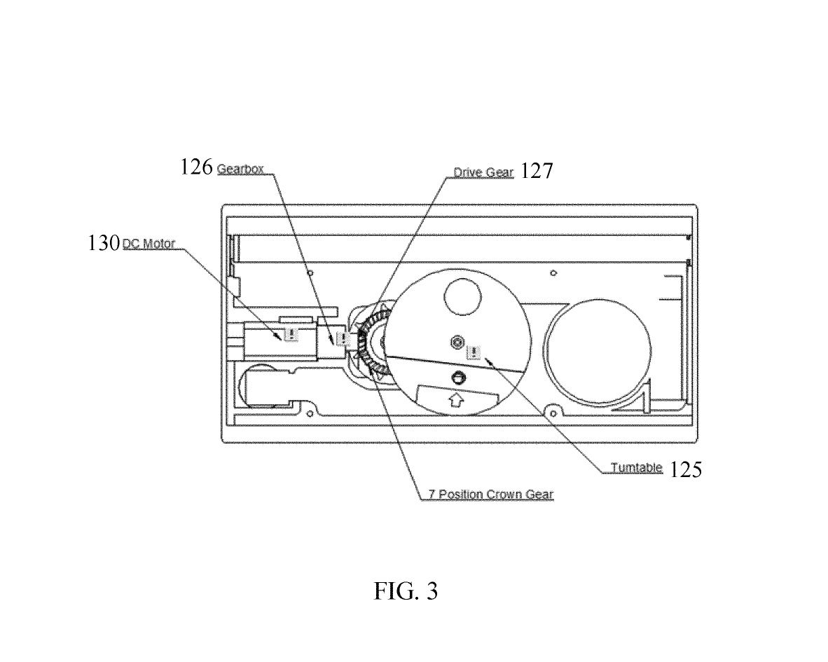

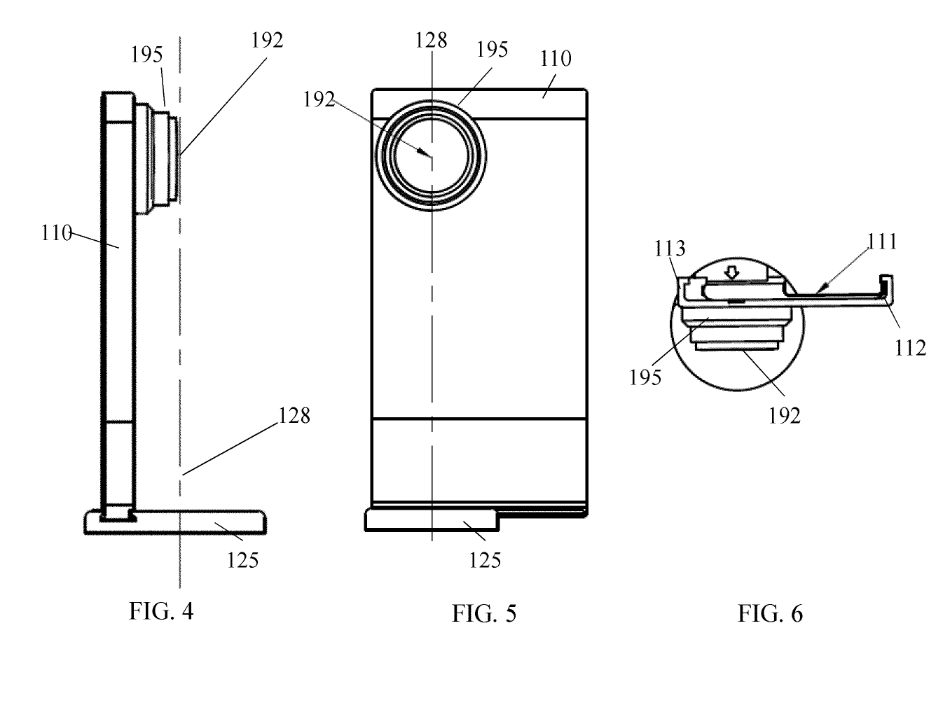

Elements of an exemplary apparatus 100 that leverages features of panoramic image capturing programs on mobile computing devices to facilitate the capture of panoramic images are depicted in FIGS. 1 and 2. The apparatus 100 includes a receptacle 110 that is configured to house a mobile computing device (not shown). A user may mount the receptacle 110 on a platform 120 by coupling the receptacle 110 to its member 125. The platform may include a motor 130 that is coupled to the member 125, as depicted in FIG. 3. In some embodiments, the motor 130 and member 125 are coupled by a drivetrain, collectively represented by the gearbox 126 and drive gear(s) 127, though other configurations for drivetrains may be used. By driving the member to different positions, the motor 130 consequently drives the mobile computing device in the receptacle 110 to different positions, as well.

To use the apparatus 100, a user inserts his or her mobile computing device in the receptacle 110 and mounts the receptacle 110 on the platform 120 (alternatively, the receptacle 110 may be permanently affixed to the platform 120, and the user may merely insert the device therein). Then, the user initiates the panoramic software of the mobile computing device 190 and activates the motor 130 to begin driving the member 125. In some embodiments, the user activates the motor by depressing a control, such as a button or any other physically tactile component (not shown). Alternatively, the control may activate the motor 130 by detecting that the mobile computing device has been coupled to the platform 120. For example, the control may be a sensor, or sensor system, that detects the presence of a mounted receptacle 110, a mobile computing device within the receptacle 110, or both, and which activates the motor 130 in response to such detection. In some embodiments, the sensor may monitor the weight applied to the member 125 and activate the motor 130 when the weight exceeds a threshold.

Upon activation, the motor 130 drives the member 125, and consequently, the mobile computing device, to move to different positions, and the motor 130 also halts motion at the positions for predefined periods of time. The motor's 125 activities are coordinated with the panoramic software of the mobile computing device. For example, the motor 130 may drive the member 125 to move at a velocity that is sufficiently high so as to be detectable by the mobile computing device 190. Because the device 190 determines that it is in motion, the device 190 refrains from capturing images for the panoramic image. Once the motor 130 halts, the motor 130 remains stationary for a sufficiently long period of time to trigger the panoramic software of the mobile computing device. In response to this stillness for a threshold period of time, the mobile computing device prepares its camera (e.g., focusing, color balancing, etc.) according to the scene in view, and captures an image.

Alternatively, upon activation, the motor 130 drives the member 125 on a continual basis. In these embodiments, the configuration of the drivetrain (e.g., gearbox 126 and drive gears 127) and the resultant movement of the member 125 is coordinated with the panoramic software of the mobile computing device, in lieu of the motor 130. Thus, for example, even though the motor 130 operates continuously, the drivetrain moves the member 125 to different positions, and also halts motion at the positions for predefined periods of time. When the device 190 recognizes that it has remained stationary for a sufficiently long period of time to trigger the panoramic software of the mobile computing device 190, the mobile computing device 190 prepares its camera according to the scene in view, and captures an image.

Thus, as these exemplary embodiments demonstrate, the apparatus 100 provides a period of stillness that is coordinated with the period of time that mobile computing device uses to recognize its physically still state and to capture an image. Thereafter, the apparatus 100 resumes driving the member 125 and mobile computing device to its next image capture position.

In this manner, the apparatus 100 and mobile computing device do not communicate with one another regarding their own operations. At no point does the mobile computing device recognize that it has been coupled to an apparatus 100. Moreover, even if a mobile computing device has not been mounted on the apparatus 100, if a user activates the motor 130, the motor 130 and/or drivetrain stills drive the member 125 through its sequence of positions, halting motion therebetween. Thus, the apparatus 100 and mobile computing device operate independently of one another, even though the apparatus 100 tailors its parameters to the features of panoramic software on the mobile computing device.

In various embodiments, the motor 130 and/or drivetrain may drive the member 125 angularly or linearly. When the motor 130 and/or drivetrain drives the member 125 angularly, the member 125 may be a turntable that rotates around an axis 128. The motor 130 and/or drivetrain may alternate between driving the member 125 to rotate by a particular number of degrees and halting the member 125 for a predefined period of time. Because the apparatus 100 facilitates capture of a panoramic image, the apparatus 100 may rotate the mobile computing device by a total of 360 degrees, throughout the sequence of its motions.

For example, the apparatus 100 may move the member 125 and mobile computing device to ten (10) positions for capturing images for a panoramic image. Thus, upon activation of the motor 130, the motor 130 and/or drivetrain drives the member 125 to rotate thirty-six (36) degrees before halting for a predefined period of time. After pausing to allow the panoramic software of the device 190 to prepare its settings and capture an image, the motor 130 and/or drivetrain drives the member 125 to rotate by another thirty-six (36) degrees before halting. The motor 130 and/or drivetrain repeats this sequence until the member 125 has been rotated a full three hundred and sixty (360) degrees. At this point, the motor 130 and/or drivetrain may halt motion altogether, and the panoramic software of the mobile computing device may recognize that the camera can no longer be expected to move, and the device begins aggregating the captured images into a single panoramic image. Although this example describes angular increments of thirty-six (36) degrees for a total of 10 positions for capturing images, any other angular increment, and corresponding number of positions, may be used.

As previously mentioned, in embodiments that drive the receptacle 110 angularly, the member 125 may be a rotary table. Furthermore, the receptacle 110 and member 125 may be configured such that, when a mobile computing device 190 is inserted into the receptacle 110, the device 190 is offset radially from the axis of rotation 128 of the member 125 by a predefined distance, so as to align the entrance pupil 192 of the lens system 195 with the axis 128. As a result, as the motor 130 and/or drivetrain drives the member 125 to rotate around its axis 128, the lens system 195 rotates around the axis 128 while the device 190 rotates around the axis 128 at an offset. The offset ensures that the mobile computing device 190 captures images suited for panoramic images, and the offset may be selected to optimize the quality of the images for this purposes. In some embodiments, the offset may be less than about 0.5 inches.

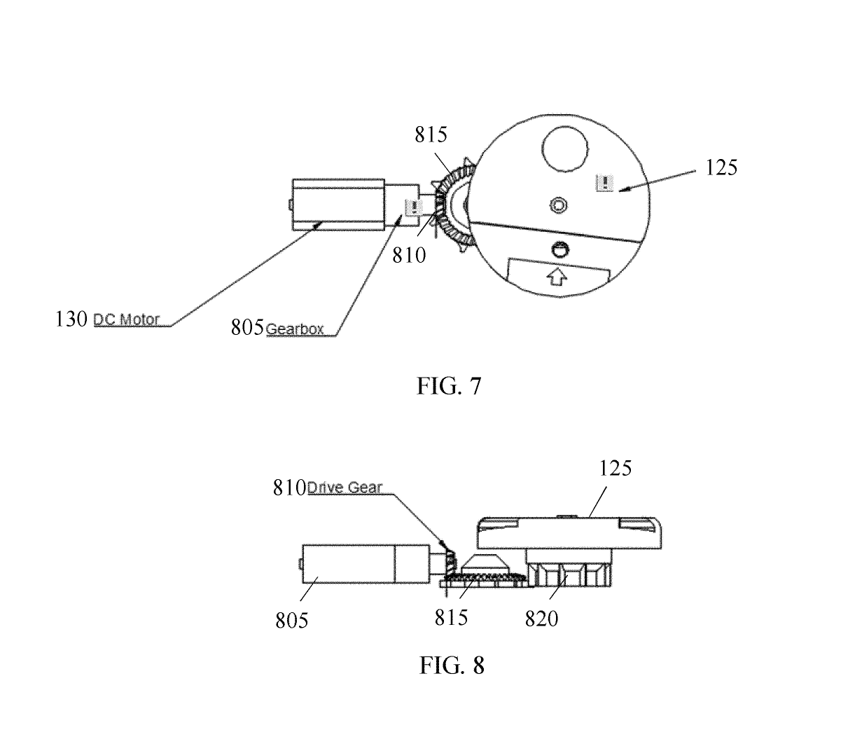

FIGS. 4 and 5 depict two exemplary views of a receptacle 110 mounted on a member 125 that illustrates a radial offset between the device 190 and the axis of rotation 128 of the member 125, which ensures alignment between the axis 128 and the lens system 195. FIG. 6 depicts an overhead view of the receptacle 110 demonstrating that the imaging system of a mobile computing device would align with the entrance pupil 192 of the receptacle 110.

When the motor 130 and/or drivetrain drives the member 125 linearly, the member 125 may progress along a linear path predefined by a groove in the platform. In these embodiments, the motor 130 and/or drivetrain drives the member 125 to move down the path by a particular distance, and halts the member 125 for a predetermined period of time before driving the member 125 further down the path. The member 125 may move at a constant velocity, although in some embodiments, the motor 130 and/or drivetrain may vary the velocity of the member 125.

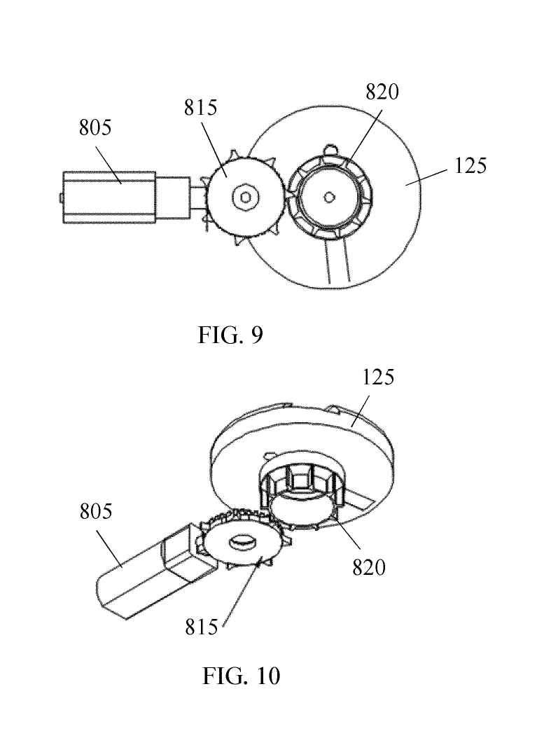

In any of the above embodiments, the member 125 may be coupled to the motor 130 via a set of gears. FIGS. 7-10 depict top, side, bottom, and isometric views of an exemplary set of gears that may be used in the platform 120 of the apparatus 100. In this embodiment, the motor 130 drives a gearbox 805 to rotate a first gear 810. The teeth of the first gear 810 are engaged with the teeth of a second gear 815, which in turn are engaged with the teeth of a third gear 820 attached to the member 125 (in this case, a rotary table). Thus, rotation of the first gear 810 via the motor 130 drives the rotation of the rotary table 125.

In many embodiments, the configuration of teeth for at least one of the gears may determine the positions that the member 125 and mobile computing device will assume. For example, one of the gears may have teeth of different length. When one of the longer teeth of a gear engages another gear in the set, motion of the member 125 begins, and motion halts when the shorter teeth of the gear fail to engage with the other gear in the set. The position where the member 125 halts depends on the position of the shorter teeth on the gear, as well as the gear's relationship to others in the set (e.g., relative size). Further, the amount of time that the member 125 remains stationary may depend on the form factor of the engaged teeth. As a result, the positions where the member 125 halts motion, as well as the duration of those periods, can be controlled by selecting the size of the gear, the angular frequency of the larger teeth, and the form factors of the larger teeth, among other parameters. In this manner, activating the motor 130 may cause the motor 130 to drive the set of gears for a predetermined period of time, but the configuration of the gears, both individually and as a set, define the positions that the member 125 and mobile computing device attain, and the length of time they remain in such positions.

Alternatively, the platform 120 may include a processor and a memory for storing computer instructions. When the motor 130 is activated, the processor may load and execute computer instructions from the memory, and these instructions may control the manner in which the motor 130 drives the member 125. For example, based on the instructions, the processor may alternate between driving the member 125 at a particular velocity for a period of time, and halting all motion. Because the parameters for motion and stillness are encoded in the computer instructions, these embodiments require simpler sets of gears than the embodiments that rely exclusively on the set of gears to determine positions for the member 125 and the length(s) of time for halting motion at the positions.

### Other Features

When the receptacle 110 has a lens system 192, the lens system 192 must be positioned so that the lens of an inserted mobile computing device 190 aligns with the lens system 192 on the receptacle 110. As shown in FIG. 6, the receptacle 110 may be configured to position a mobile computing device 190 to ensure this alignment. Enabling the device to leverage its own lens and the lens system 192 of the receptacle 110 can improve the quality of images obtained for panoramic images. As discussed above, and depicted in FIG. 4, the lens system 192 of the receptacle 100 must also be positioned so that its entrance pupil 192 is aligned with the axis of rotation 128 of the member 125.

Although the embodiments depicted in FIGS. 2 and 4-6 illustrate a lens system 195 affixed to the receptacle 110, and positioned to align with the lens of the mobile computing device, in various embodiments, the receptacle 110 does not have an attached lens system 195. Instead, the mobile computing device includes the sole lens (or lenses) used for image capture. The receptacle 110 would still be configured to position the entrance pupil of the lens of the mobile computing device according to the same principles guiding the positioning of the lens system 192 affixed to a receptacle 110.

As depicted in FIGS. 2 and 6, the receptacle 110 includes an open sleeve 111 with arms 112, 113 configured to receive a mobile computing device 190. A user may insert the device into the sleeve 111, and the arms 112, 113 hold the device in place. However, any other mechanism for maintaining the position of the mobile computing device may be used. For example, the receptacle 110 may include a slot 111 whose front and back faces define a space for housing the device. In another example, the receptacle 110 may include clamps that hold the device in place. Alternatively, the receptacle 110 may include flexible molded components that define at least part of the perimeter of the space for housing the device. When a user presses the device into the space, the component flex to accept and secure the device.

Furthermore, the receptacle 110 may be mounted on the platform 120 in any manner desired. In FIGS. 1, 2, 4, and 5, the receptacle 110 is coupled to the member 125 by sliding a portion of the receptacle 110 into a groove of the member 125. However, any other method of mounting or coupling may be used. For example, the receptacle 110 may include one or more pins, and the member 125 may include one or more holes that receive the pins of the receptacle 110.

The embodiments of the invention described above are intended to be merely exemplary; numerous variations and modifications will be apparent to those skilled in the art. All such variations and modifications are intended to be within the scope of the present invention as defined in any appended claims.

What is claimed is:

1. A portable device for facilitating capture of panoramic images on a mobile computing device, the device comprising:
a receptacle configured to house a mobile computing device; and
a platform comprising (1) a member, with an axis of rotation, configured to interface with the receptacle to offset radially the mobile computing device from the axis of rotation by a predefined distance such that an entrance pupil of a lens system of the mobile computing device is aligned with the axis, and (2) a motor that drives the member at different velocities so that the mobile computing device captures an image for a panoramic image when a velocity of the member is substantially zero for a threshold period of time.

2. The portable device of claim 1, wherein the velocities are angular velocities.

3. The portable device of claim 1, wherein the member is a circular member.

4. The portable device of claim 1, wherein the motor is a mechanical motor.

5. The portable device of claim 1, wherein the motor is coupled to a processor that executes code to drive the member.

6. The portable device of claim 1, wherein the motor drives the member to alternate between rotating and remaining still.

7. The portable device of claim 6, wherein the motor drives the member to rotate by a predetermined number of degrees.

8. The portable device of claim 7, wherein the predetermined number of degrees is thirty-six (36).

9. The portable device of claim 1, further comprising a drivetrain coupled to the motor and the member, wherein the motor drives the member by driving the drivetrain.

10. The portable device of claim 9, wherein the drivetrain comprises at least one drive gear with teeth of different lengths, wherein the teeth of different lengths determine the different velocities at which the member is driven.

11. The portable device of claim 1, wherein the predefined distance of radial offset between the mobile computing device and the axis of rotation of the member is less than 0.5 inches.

12. A method for facilitating capture of panoramic images on a mobile computing device, the method comprising:
initiating, by a mobile computing device, a program to capture images of a scene for a panoramic image when the mobile computing device is stationary;
capturing, by a mobile computing device, a first image of a scene at a first location;
driving, by a motor, a member configured to interface with a receptacle containing the mobile computing device from the first location to a second location;
halting, by the motor, further motion of the member for a predetermined period of time;
determining, by a sensor of the mobile computing device, a lack of motion of the mobile computing device for a threshold period of time;
in response to the lack of motion, capturing, by the mobile computing device, a second image of the scene at the second location; and
creating the panoramic image from the first and second images of the scene.

13. The method of claim 12, wherein driving the member comprises:
driving, by the motor, the member from the first location to the second location at a non-zero angular velocity.

14. The method of claim 12, wherein driving the member comprises:
driving, by the motor, the member to rotate from the first location to the second location.

15. The method of claim 12, wherein driving the member comprises:
driving, by the motor, the member to rotate by a predetermined number of degrees.

16. The method of claim 12, wherein driving the member comprises:
driving, by the motor, a drivetrain coupled to the member, wherein the drivetrain comprises at least one drive gear with teeth of different lengths and positions of the teeth of different lengths determine when the member halts.

17. A computer-readable medium having computer program code non-transitorily stored thereon, the computer program code for facilitating capture of panoramic images on a mobile computing device, the program code comprising:
program code for monitoring motion of the mobile computing device, including substantially zero and substantially non-zero velocities of the mobile computing device; and
program code for capturing at least one image of a scene in response to determinations that the mobile computing device has remained at a substantially zero velocity for a threshold period of time.
